(19) United States
(12) Patent Application Publication
(10) Pub. No.: US 2012/0288826 A1
(43) Pub. Date: Nov. 15, 2012

(54) Dental Implants and Methods for Their Insertion into Patients

(76) Inventor: Russell P. Fitton, III, Barrington, IL (US)

(21) Appl. No.: 13/105,662

(22) Filed: May 11, 2011

(51) Int. Cl. A61C 8/00

(52) U.S. Cl. 433/174

(57) ABSTRACT

A dental implant includes a threaded fixture, at least a portion of which is configured for implantation into bone in a patient's jaw, and an abutment configured for coupling to the threaded fixture, at least a portion of which is configured to remain above the patient's gum line. The threaded fixture and/or the abutment are configured to receive torque from a complementarily shaped torque-transmitting tool. A method for inserting a dental implant into a patient includes (a) implanting at least a portion of a threaded fixture into a hole in a patient's jawbone configured for receiving the threaded fixture; (b) inserting an abutment into the threaded fixture, where at least a portion of the abutment is configured to remain above the patient's gum line; and (c) applying torque to a first part of the dental implant while simultaneously applying counter-torque to the threaded fixture and/or the abutment.

### TECHNICAL FIELD

The present teachings relate generally to dental implants and, more particularly, to root-form endosseous dental implants and their associated components.

### BACKGROUND

Among the available alternatives for the replacement of a missing tooth (or teeth), the use of dental implants can provide certain advantages over conventional dental bridges and removable prostheses (e.g., a partial or full denture).

Typically, a dental implant is implanted into a patient's jawbone via a multi-step process. In one stage of this process, an abutment—which eventually will support the dental prosthesis, and which can be either fixed (e.g., a crown or bridge) or removable (e.g., a denture)—is attached to the implant. However, as torque is applied to the abutment during the tightening process, an undesirable concomitant torquing force is applied directly to the implant. This undesirable force placed on the implant can damage the bone-implant interface referred to as osseointegration. If the bone-implant interface is completely disrupted, turning of the implant in the jawbone oftentimes occurs, resulting in a so-called “spinner,” and the implant is completely lost. Partial disruption of the bone-implant interface, while not immediately apparent, can eventually lead to premature failure of the implant. This problem becomes particularly pronounced when the implant is embedded in bone of poor quality or density, which is more common in but not limited to the upper jaw.

When restoring a dental implant that has been placed into a patient's jawbone, it would be highly desirable to avoid damaging the osseointegration of the bone-implant interface when torqueing down the abutment in the implant.

### SUMMARY

The scope of the present invention is defined solely by the appended claims, and is not affected to any degree by the statements within this summary.

By way of introduction, a first dental implant embodying features of the present teachings includes a threaded fixture, at least a portion of which is configured for implantation into bone in a patient's jaw, and a neck contiguous with the threaded fixture. At least a portion of the neck is configured to remain above bone level when the portion of the threaded fixture is implanted in the patient's bone. An exterior surface of the neck includes an out-of-round shape configured to receive torque from a complementarily shaped torque-transmitting tool.

A second dental implant embodying features of the present teachings includes an abutment that includes an external out-of-round portion configured to receive torque from a complementarily shaped torque-transmitting tool. The abutment is configured for coupling to a threaded fixture, at least a portion of which is configured for implantation into bone in a patient's jaw, and at least a portion of the abutment is configured to remain above the patient's gum line.

A third dental implant embodying features of the present teachings includes a threaded fixture, at least a portion of which is configured for implantation into bone in a patient's jaw, and an abutment configured for coupling to the threaded fixture, at least a portion of which is configured to remain above the patient's gum line. The threaded fixture and/or the abutment include means for receiving torque from a complementarily shaped torque-transmitting tool.

A method for inserting a dental implant into a patient embodying features of the present teachings includes (a) implanting at least a portion of a threaded fixture into a hole in a patient's jawbone configured for receiving the threaded fixture; (b) inserting an abutment into the threaded fixture, wherein at least a portion of the abutment is configured to remain above the patient's gum line; and (c) applying torque to a first part of the dental implant while simultaneously applying counter-torque to the threaded fixture and/or the abutment.

### BRIEF DESCRIPTION OF THE DRAWINGS

FIG. 1 shows a perspective view of a first dental implant comprising a hexagonal out-of-round external neck portion.

FIG. 2 shows a cross-sectional view of the dental implant shown in FIG. 1, taken along its longitudinal axis, when implanted in a jawbone.

FIG. 3 shows a top plan view of the dental implant shown in FIG. 1.

FIG. 4 shows a perspective view of a second dental implant comprising an alternative out-of-round external neck portion.

FIG. 5 shows a top plan view of the dental implant shown in FIG. 4.

FIG. 6 shows an exploded perspective view of a dental implant similar to that shown in FIG. 1 when implanted in a jawbone, and a solid abutment configured for insertion therein.

FIG. 7 shows a perspective view of a third dental implant comprising a hexagonal out-of-round external neck portion and an internal hex.

FIG. 8 shows a perspective view of a fourth dental implant comprising a tri-lobe interlocking chamber in an interior thereof.

FIG. 9 shows a perspective view of a fifth dental implant comprising a hollow, frustoconically-shaped abutment having a hexagonal out-of-round external neck portion.

FIG. 10 shows a perspective view of a sixth dental implant comprising a hollow, frustoconically-shaped abutment having a pair of opposing flat surfaces on its frustoconical portion.

### DETAILED DESCRIPTION

As further described below, the present inventor has found that by applying torque to a threaded fixture implanted in a jawbone while simultaneously applying counter-torque to a complementary abutment coupled thereto or, alternatively, by applying torque to a hollow abutment coupled to a threaded fixture implanted in a jawbone while simultaneously applying counter-torque to an element received within the abutment (e.g., a threaded element that engages with an interior cavity of the threaded fixture), the risk of creating undesirable spinners can be reduced. The inability to adequately apply such torque and counter-torque in conventional dental implants stems from the fact that those portions of the dental implant that typically lie above a patient's jawbone are generally smooth and curved and, as such, do not present suitable surfaces for gripping by torque-transmitting tools. Dental implants exhibiting reduced tendency to spin in a patient's jawbone during installation have likewise been discovered and are described hereinbelow.

Throughout this description and in the appended claims, the following definitions are to be understood:

As a matter of convenience, the designations “above” and “below” as used in reference to a patient's jawbone, gumline or the like are intended to describe whether an element lies outside (i.e., “above”) or inside (i.e., “below”) the jawbone or gumline as opposed to whether the element is actually physically higher or lower than the jawbone and/or gumline. The latter physical determination is absolute and depends on whether an element is being described relative to the upper or lower jaw of a patient; as such, it is not relevant to the present description. Thus, for the sake of clarity and unless otherwise noted, the term “above” as used herein generally refers to a location that lies at least in part outside of a patient's upper and/or lower jawbone, gumline or the like, whereas the term “below” generally refers to a location that lies at least in part inside of a patient's upper and/or lower jawbone, gumline or the like.

The term “fixture” refers to a portion of a dental implant configured for implantation into a patient's jawbone (i.e., alveolar bone) and for eventual osseointegration. The fixture serves as a root for the tooth to be replaced and, in some embodiments, the fixture (or at least a portion thereof) is configured to lie below the patient's gum line.

The term “abutment” refers to a stub configured for coupling to the fixture, such that it lies at or above the patient's gum line, and further configured for the eventual support of a dental prosthesis (e.g., a crown, a bridge, or the like). In some embodiments, an abutment in accordance with the present teachings is substantially solid. In other embodiments, an abutment in accordance with the present teachings is at least in part hollow. In some embodiments, a hollow abutment in accordance with the present teachings is configured to receive a further element (e.g., a fastener) that can engage with an interior of the fixture.

The term “coupled” is intended broadly to encompass both direct and indirect coupling. Thus, first and second parts are said to be coupled together when they are directly connected and/or functionally engaged (e.g. by direct contact), as well as when the first part is functionally engaged with an intermediate part, which is functionally engaged either directly or via one or more additional intermediate parts with the second part. Also, two elements are said to be coupled when they are functionally engaged (directly or indirectly) at some times and not functionally engaged at other times.

Representative dental implants in accordance with the present teachings will now be described in reference to the attached drawings. It is to be understood, however, that the various depictions in the drawings are intended as being merely illustrative of principles described herein, and that alternative dental implant designs (including but not limited to the conventional designs reported heretofore) can also be readily adapted for use in accordance with the present teachings.

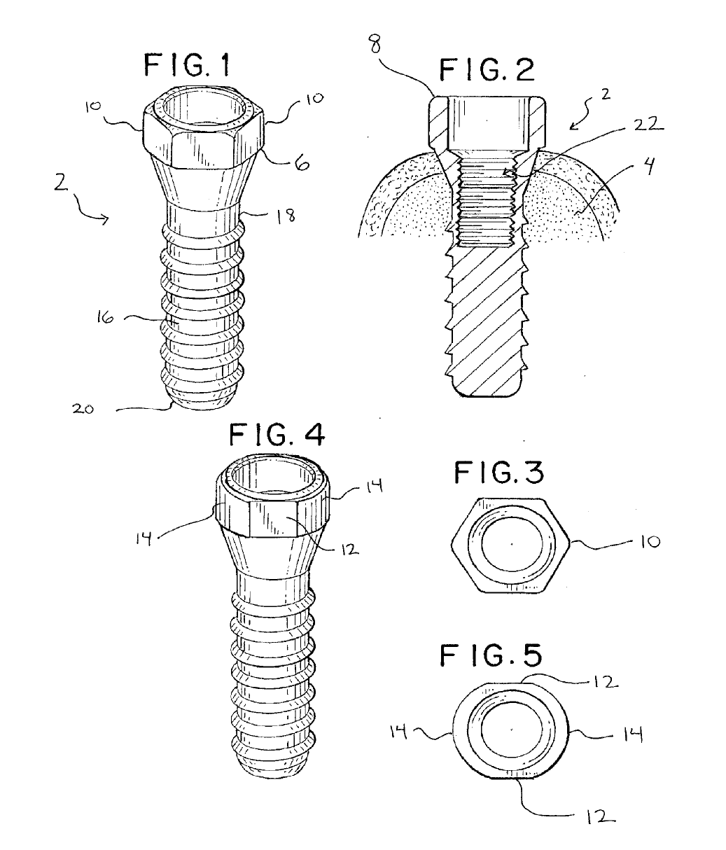

By way of general introduction, as best shown in FIGS. 1 and 2, a first dental implant embodying features of the present teachings comprises (a) a threaded fixture 2 at least a portion of which is configured for implantation into bone 4 in a patient's jaw; and (b) a neck 6 contiguous with the threaded fixture 2, wherein at least a portion 8 of the neck 6 is configured to remain above bone level when the portion of the threaded fixture 2 is implanted in the patient's bone. An exterior surface of the neck 6 comprises an out-of-round shape 10 configured to receive torque from a complementarily shaped torque-transmitting tool (not shown).

In some embodiments, the out-of-round shape 10 is hexagonal, as shown in FIGS. 1, 2, and 3. In alternative embodiments, the out-of-round shape comprises at least one pair of opposing flat surfaces 12, as shown by FIGS. 4 and 5 (e.g., with one or more additional segments 14 being curved). In some embodiments, the threaded fixture 2 is substantially cylindrical in shape and, in some embodiments, the threaded fixture tapers away from the neck 6.

Titanium metal and alloys thereof are well suited for use in accordance with the present teachings since bone has the tendency to grow in such close proximity to titanium as to be, in essence, adhered to the titanium. Accordingly, in some embodiments, dental implants in accordance with the present teachings comprise titanium, which is available in one of four grades depending upon the amount of carbon and iron it contains. In some embodiments, dental implants in accordance with the present teachings comprise a titanium alloy, including but not limited to Titanium 6AL-4V (an alloy that contains 6% aluminum and 4% vanadium), which is thought to exhibit an osseointegration level similar to that of pure titanium while providing better tensile strength and fracture resistance. In alternative embodiments, dental implants in accordance with the present teachings comprise zirconia (ZrO₂), an oxide of zirconium that exhibits a bright tooth-like color.

In some embodiments, one or more surfaces of a dental implant in accordance with the present teachings may be modified by a technique selected from the group consisting of etching (e.g., machining, grit-blasting, microscopic etching, etc.), plasma spraying, anodizing, sandblasting, and the like, and combinations thereof in order to increase the surface area and integration potential of the implant. In some embodiments, one or more surfaces of a dental implant in accordance with the present teachings may be coated with a biocompatible bone regeneration material for promoting osseointegration, including by not limited to hydroxyapatite (HA).

In some embodiments, as show for example in FIG. 1, dental implants in accordance with the present teachings have a cylindrical outer contour 16. In some embodiments, the threaded fixture 2 is cylindrical in the apical region 18, becoming slightly conical in the coronal part 20 of the implant leading to a mild taper. In some embodiments, the threaded fixture 2 is provided with a cutting groove to facilitate its placement in a patient's jawbone.

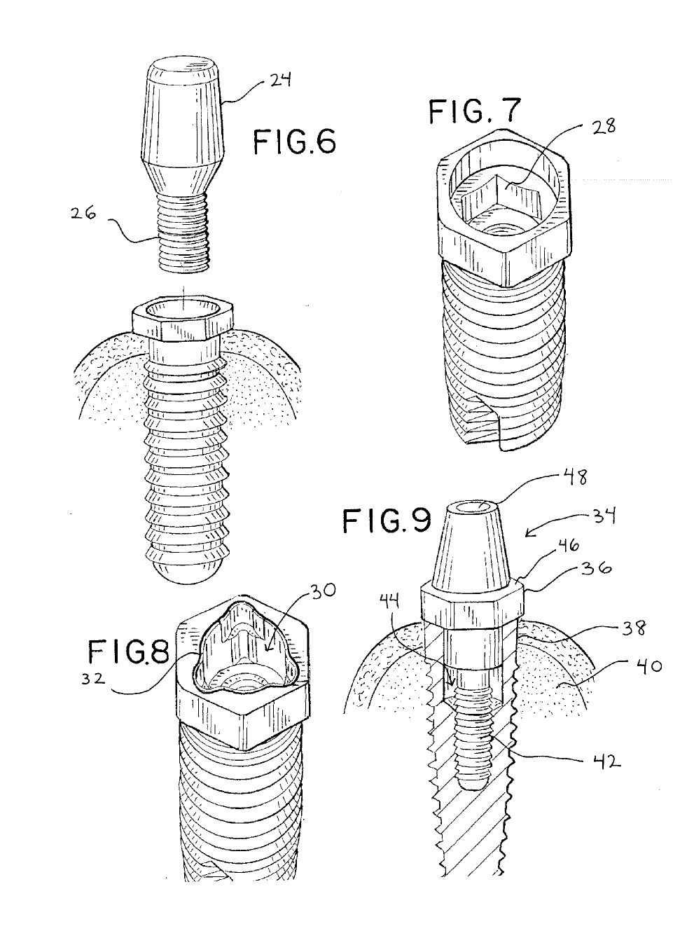

In some embodiments, at least a portion of the dental implant is hollow. In some embodiments, as best shown by FIG. 2, at least a portion of the threaded fixture 2 is hollow, such that an interior 22 of the threaded fixture 2 is configured to receive an abutment 24, as shown in FIG. 6. In some embodiments, at least a portion of the interior 22 of the fixture 2 is threaded, such that it is configured to receive a complementary thread 26 on an abutment.

In some embodiments, an interior cavity of the threaded fixture contains an internal hex 28, as shown in FIG. 7, which provides resistance against loosening of the abutment in its friction fit. Representative such designs for the internal hex include but are not limited to those described in U.S. Pat. No. 4,960,381—the entire contents of which are hereby incorporated by reference, except that in the event of any inconsistent disclosure or definition from the present specification, the disclosure or definition herein shall be deemed to prevail.

In some embodiments, an interior cavity of the threaded fixture contains a Morse taper, which provides resistance against loosening of the abutment in its friction fit and/or reduces the available pathways for bacterial migration. Representative such designs for the Morse taper include but are not limited to those described in U.S. Pat. No. 5,417,570—the entire contents of which are hereby incorporated by reference, except that in the event of any inconsistent disclosure or definition from the present specification, the disclosure or definition herein shall be deemed to prevail.

In some embodiments, the interior of the threaded fixture 2 comprises an interlocking chamber 30 configured to receive and engage with one or more complementarily shaped portions of the abutment. In some embodiments, as shown in FIG. 8, the interlocking chamber comprises a tri-lobe configuration 32, such as that shown and described in U.S. Pat. No. 7,108,510 B2—the entire contents of which are hereby incorporated by reference, except that in the event of any inconsistent disclosure or definition from the present specification, the disclosure or definition herein shall be deemed to prevail.

As shown in FIG. 9, a second dental implant embodying features of the present teachings comprises an abutment 34 that comprises an external out-of-round portion 36 configured to receive torque from a complementarily shaped torque-transmitting tool. In some embodiments, the abutment 34 is configured for coupling to a threaded fixture 38, at least a portion of which is configured for implantation into bone 40 in a patient's jaw. In some embodiments, the abutment 34 comprises a threaded portion 42 configured for insertion into a cavity 44 in the threaded fixture 38. In some embodiments, the threaded portion 42 of the abutment 34 comprises a thread that is complementary to a thread on an interior surface of the cavity 44.

In some embodiments, as shown in FIG. 9, the abutment 34—rather than or in addition to the threaded fixture 38—comprises an out-of-round shape 36 configured to receive counter-torque from a complementarily shaped torque-transmitting tool. In other words, the abutment 34 can be used with a threaded fixture in accordance with the present teachings and/or with a conventional threaded fixture. In some embodiments, the out-of-round shape 36 on the abutment 34 comprises at least one pair of opposing flat surfaces. In some embodiments, as shown in FIG. 9, the out-of-round shape 36 provided on the abutment 34 is hexagonal. In some embodiments, as shown in FIG. 9, the out-of-round portion 36 of the abutment 34 is provided on a neck 46 of the abutment 34. In other embodiments, as further described below, an out-of-round portion is provided on a portion of the abutment further distanced from a point of contact between the abutment and the threaded fixture.

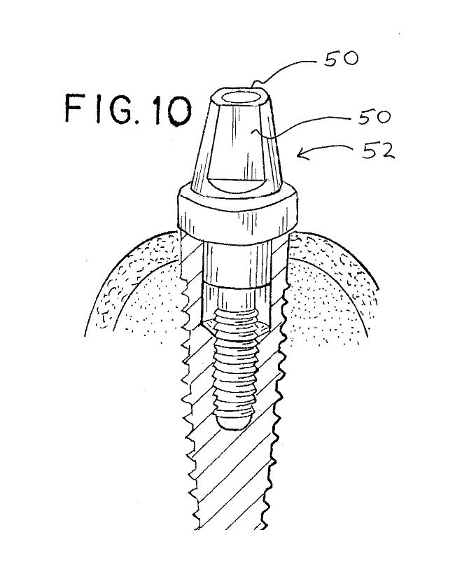

In some embodiments, at least a portion of the abutment is configured to remain above a patient's gumline and/or jawbone. In some embodiments, the abutment is coupled to a fixture that that has been countersunk into the jawbone, such that the fixture itself cannot be used to provide counter-torque. As shown in FIG. 9, in some embodiments, the portion of the abutment 34 configured to remain above a patient's gum line is substantially frustoconically shaped. In some embodiments, as shown in FIG. 9, the abutment 34 is hollow and provides a channel 48 configured to communicate with the interior cavity 44 of the fixture 38. In some embodiments, the channel 48 is configured to receive a fastener (not shown) that passes through the channel 48 and engages with the interior 44 of the fixture 38 (e.g., by threading into a complementary thread in the interior of the fixture). In some embodiments, torque-receiving means (e.g., at least one pair of opposing flat surfaces) are provided on the fastener received within the hollow abutment and the fixture, such that the fastener becomes an extension of the fixture. In some embodiments, the out-of-round portion 36 of the abutment 34 comprises at least one pair of opposing flat surfaces. In some embodiments, as shown in FIG. 10, at least one pair of opposing flat surfaces 50 is provided on the frustoconical portion of the abutment 52 itself.

A third dental implant embodying features of the present teachings comprises (a) a threaded fixture at least a portion of which is configured for implantation into bone in a patient's jaw; and (b) an abutment configured for coupling to the threaded fixture, wherein at least a portion of the abutment is configured to remain above the patient's gum line. The threaded fixture and/or the abutment comprise means for receiving torque from a complementarily shaped torque-transmitting tool.

In some embodiments, the torque-receiving means provided on the threaded fixture and/or the abutment comprise an out-of-round shape configured to receive torque from a complementarily shaped torque-transmitting tool (e.g., a box wrench, pliers or the like). In some embodiments, the out-of-round shape comprises at least one pair of opposing flat surfaces. In some embodiments, the out-of-round shape is square. In some embodiments, the out-of-round shape is hexagonal. In some embodiments, the out-of-round shape is octagonal.

By way of further general introduction, a method for inserting a dental implant into a patient embodying features of the present teachings includes (a) implanting at least a portion of a threaded fixture into a hole in a patient's jawbone configured for receiving the threaded fixture; (b) inserting an abutment into the threaded fixture, wherein at least a portion of the abutment is configured to remain above the patient's gum line; and (c) applying torque to a first part of the dental implant while simultaneously applying counter-torque to the threaded fixture and/or the abutment.

In some embodiments, the first part of the dental implant corresponds to the abutment and counter-torque is applied to the threaded fixture. In some embodiments, the abutment is hollow and provides a channel configured to communicate with an interior cavity of the threaded fixture. In some embodiments, the first part of the dental implant comprises a threaded element at least a part of which is configured to be received in the interior cavity of the threaded fixture, and counter-torque is applied to the abutment. In some embodiments, the method further comprises preparing a hole in the jawbone at the site at which the dental implant is to be implanted. In some embodiments, the method further comprises attaching a dental prosthesis (e.g., single-unit restorations, multiple-unit restorations, and/or full-arch restorations) to the abutment. In some embodiments, the dental prosthesis (e.g., a crown, a bridge, a partial or full denture, etc.) is attached to the abutment using an adhesive. In some embodiments, the dental prosthesis is attached to the abutment by a friction-fit. In some embodiments, the dental prosthesis is attached to the abutment by a screw-type mechanism.

The foregoing detailed description and accompanying drawings have been provided by way of explanation and illustration, and are not intended to limit the scope of the appended claims. Many variations in the presently preferred embodiments illustrated herein will be apparent to one of ordinary skill in the art, and remain within the scope of the appended claims and their equivalents.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding claim—whether independent or dependent—and that such new combinations are to be understood as forming a part of the present specification.

1. A dental implant comprising:
a threaded fixture at least a portion of which is configured for implantation into bone in a patient's jaw;
a neck contiguous with the threaded fixture, wherein at least a portion of the neck is configured to remain above bone level when the portion of the threaded fixture is implanted in the patient's bone;
an abutment configured for coupling to the threaded fixture; and
a fastener configured for coupling to the threaded fixture through the abutment;
wherein the threaded fixture comprises an interior cavity;
wherein the abutment comprises a channel configured to communicate with the interior cavity of the threaded fixture;
wherein the fastener is configured to pass through the channel in the abutment and create an engagement between a thread of the fastener and a complementary thread of the interior cavity of the threaded fixture; and
wherein an exterior surface of the neck comprises an out-of-round shape configured to receive torque from a complementarily shaped torque-transmitting tool.

2. The invention of claim 1 wherein the out-of-round shape comprises at least one pair of opposing flat surfaces.

3. The invention of claim 1 wherein the out-of-round shape is hexagonal.

4. The invention of claim 1 wherein the threaded fixture is substantially cylindrical in shape.

5. The invention of claim 1 wherein the threaded fixture tapers away from the neck.

6. The invention of claim 1 wherein the threaded fixture comprises titanium.

7. The invention of claim 1 wherein the threaded fixture comprises an alloy of titanium.

8. The invention of claim 1 wherein at least a portion of the threaded fixture comprises a coating comprising hydroxyapatite.

9. The invention of claim 1 wherein at least a portion of the threaded fixture is microscopically etched.

10. (canceled)

11. The invention of claim 1 wherein at least a portion of the cavity is threaded.

12. The invention of claim 1 wherein the cavity comprises an internal hex.

13. The invention of claim 1 wherein the threaded fixture further comprises a Morse taper.

14. (canceled)

15. The invention of claim 1 wherein an interior of the threaded fixture comprises an interlocking chamber configured to receive and engage with one or more complementarily shaped portions of the abutment.

16. The invention of claim 15 wherein the interlocking chamber comprises a tri-lobe configuration.

17. The invention of claim 1 wherein the abutment comprises an out-of-round shape configured to receive counter-torque from a complementarily shaped torque-transmitting tool.

18. The invention of claim 17 wherein the out-of-round shape of the abutment comprises at least one pair of opposing flat surfaces.

19. The invention of claim 1 wherein at least a portion of the abutment is configured to remain above the patient's gum line.

20. The invention of claim 19 wherein the portion of the abutment is substantially frustoconically shaped.

21. (canceled)

22. A dental implant comprising:
an abutment that comprises an external out-of-round portion configured to receive torque from a complementarily shaped torque-transmitting tool; and
a fastener;
wherein the abutment is configured for coupling to a threaded fixture, at least a portion of which is configured for implantation into bone in a patient's jaw;
wherein at least a portion of the abutment is configured to remain above the patient's gum line;
wherein the abutment comprises a channel configured to communicate with an interior cavity of the threaded fixture; and
wherein the fastener is configured to pass through the channel in the abutment and create an engagement between a thread of the fastener and a complementary thread of the interior cavity of the threaded fixture.

23. The invention of claim 22 wherein the out-of-round portion comprises at least one pair of opposing flat surfaces.

24. The invention of claim 22 wherein the out-of-round portion comprises a hexagonal shape.

25. The invention of claim 22 wherein the abutment further comprises a threaded portion configured for insertion into the cavity in the threaded fixture.

26. The invention of claim 25 wherein the threaded portion comprises a thread that is complementary to a thread on an interior surface of the cavity.

27. The invention of claim 22 wherein the portion of the abutment configured to remain above the patient's gum line is substantially frustoconically shaped.

28-32. (canceled)

33. A method for inserting a dental implant into a patient comprising:
implanting at least a portion of a threaded fixture into a hole in a patient's jawbone configured for receiving the threaded fixture, wherein an exterior surface of the threaded fixture comprises out-of-round surfaces;
inserting an abutment into the threaded fixture, wherein at least a portion of the abutment is configured to remain above the patient's gum line, and wherein an exterior surface of the abutment comprises out-of-round surfaces;
gripping the out-of-round surfaces of the abutment with a first torque-transmitting hand tool;
gripping the out-of-round surfaces of the threaded fixture with a second torque-transmitting hand tool; and
applying torque to the out-of-round surfaces of the abutment with the first torque-transmitting hand tool while simultaneously applying counter-torque to the out-of-round surfaces of the threaded fixture with the second torque-transmitting hand tool.

34. (canceled)

35. The invention of claim 33 wherein the abutment is hollow and provides a channel configured to communicate with an interior cavity of the threaded fixture, wherein the interior cavity of the threaded fixture is configured to receive at least a part of a threaded element through the channel in the abutment, the method further comprising applying torque to a threaded element while simultaneously applying counter-torque to the abutment.

36. The invention of claim 33 further comprising preparing a hole in the jawbone at the site at which the dental implant is to be implanted.
